(19) United States
(12) Patent Application Publication
(10) Pub. No.: US 2011/0082763 A1
(43) Pub. Date: Apr. 7, 2011

(54) COMPUTER-IMPLEMENTED METHOD OF PERFORMING ACTS OF TRADE AND COMPUTER SYSTEM THEREFOR

(75) Inventors: Luis Roberto Pereira Leite, Santos, SP (BR); Paulo Rogerio Vieira, Sao Paulo, SP (BR)

(73) Assignee: E_Comprando Ltda.-Me, Santos, SP (BR)

(21) Appl. No.: 12/504,362

(22) Filed: Jul. 16, 2009

(51) Int. Cl. G06Q 30/00

(52) U.S. Cl. 705/26.7; 705/26.8

(57) ABSTRACT

A computer-implemented method electronically promotes simpler acts of purchase in a relation between a group of vendors and a shopper, whereby the buyer accesses a single front end interface, and goes through a one-time only act of registration procedure.

This invention concerns, in the broad sense, the electronic trading of goods, services and products. More particularly, the invention concerns a method of electronically promoting simpler acts of purchase in a relation between a shopper and a group of vendors, whereby the shopper accesses a single front end interface, and goes through a one-time only act of data registration procedure.

### BACKGROUND

Many alternatives of electronic trade, or E-commerce, are presently known and practiced.

In one of those alternatives, the ordinary trade situation involves distinct operations in a known order: product search, product selection, and product purchase. A typical trade (purchase/sale) event is as follows: a user (a potential buyer or shopper) logs onto an Internet site of a certain vendor of goods or services, and searches for a specific item or browses through a catalog of items. Whenever an item of interest is found, matching the user's desires, the user may add it to a “shopping cart”—from that point the user may either go back to searching for more goods, later adding more goods to the shopping cart, or go directly to the “checkout” procedure, through which the transaction will be effected. To execute a purchase, the user needs to have previously registered his personal data with that specific vendor or else he is directed to provide such data. After the system identifies the user, the user chooses product delivery information and payment method according to the conditions set forth by the store, and finalizes the purchase.

Every time this user wants to purchase products from other vendors, the same or similar steps will happen again, including running another search and one more time providing the same, or similar data already disclosed to the prior vendor, such as personal data, preferences, etc. This lack of integration among E-commerce stores or vendors is a deficiency that forces the consumer to have multiple virtual identities (personal data, passwords, etc), consequently generating one or more of the following negative results: loss of time; inconsistent data; disincentive to purchase in stores without prior relationship; the vendor may be less exposed to larger numbers of shoppers, and consequently has less chances of boosting sales.

This invention provides a solution to that problem, creating a unified front to search in several stores at the same time, with a unique identity of the consumer, managed automatically, facilitating purchases and allowing obtaining more complete and more updated data about each consumer.

### SUMMARY OF THE INVENTION

This invention relates to a computer-implemented method of facilitating e-commerce transactions, and a system to deploy it. It simplifies and automates the techniques involved in the operations currently performed by the user who uses the a computer network like the Internet to search, choose, and buy goods and/or products.

The method of the invention is presented, through which users can access a number of third-party e-commerce stores, with the aid of a support system. Users may search those stores' catalogs for items (goods or services) in a single site, and the support system will present search results from different stores in a unified way. The system may rank those results according to user preferences and history. As part of this invention, a single shopping cart is provided, onto which users may add items offered by different stores. Should users decide to make a purchase, the support system facilitates the checkout process by a one time procedure of creating accounts for the user on each store, filling in account details provided by the users or importing from other stores with which users already have a relationship. The system also guides the users through payment and shipping processing.

This invention is different from the prior art U.S. Pat. No. 7,222,087 which does not encompass the situation of a shopper searching, choosing and buying goods or services from multiple vendors, in only one ambience.

This invention is also different from the prior art U.S. Pat. No. 7,493,283, which concerns a method of conducting an e-commerce transaction by using personal account information of a user associated with a credit card.

The invention is also different from the prior art U.S. Pat. No. 7,478,057, which concerns a method of conducting an e-commerce transaction between a user and a merchant—no provision to a relationship between a user and several merchants at the same time is mentioned.

The following prior art pieces, though with some similarity, are also not relevant with respect of novelty and non-obviousness of the present invention: WO2006060849, US2009106162, 20060020540, WO9933012, US2009063295.

### BRIEF DESCRIPTION OF THE DRAWINGS

FIG. 1 illustrates an exemplary computer-implemented method of performing acts of trade.

### DESCRIPTION OF THE INVENTION

In the context of this document, the following terms are used with the following meanings:
By “shopper” it is meant any user of the e-commerce system, who interacts with it through a interface like a web browser, an application for mobile devices (cell phones, smart phones), or any equivalent means. A shopper uses the system to search for products and/or to compare the offerings of different stores, and effects purchase acts. A shopper needs to have an account in order to complete a purchase.
By “account” it is meant a set of information, for instance a set of personal data, a set of preferences, a set of historical data, a set of corresponding accounts in stores integrated by the system, etc.
By “preferences” it is meant one or more criteria such as product price, shipping price, time to delivery, merchant rating, and any other that may be used to rank goods for display to the user.
By “store” it is meant any e-commerce store or vendor, which sells goods and services over a computer network, preferably the Internet, through a web site, typically with automated payment processing.
By “integrated stores” it is meant e-commerce stores or vendors sharing resources and data so the shopper has access to the available stock of the stores as a whole, in a single ambience, without having to register more than only once to purchase items;
By “integration” it is meant the interaction means among integrated stores, allowing searching and browsing for products, analyzing the resulting web pages to extract relevant information that is displayed to the user in the system's own web pages (typically a unified front end interface), creating, retrieving, and updating account information details for the user, adding goods to the user's shopping cart, and submitting purchase orders on behalf of the user.
By “system” it is meant the hardware and software that together allow the integration of the stores, so as to present to a user a front end interface where the available stock of the integrated stores can be searched, desired items can be chosen and purchased, with only one act of registration of the shopper.
By “goods”, except with express indication otherwise, it is meant goods and services.

In one aspect, the invention concerns a method of performing electronic acts of trade based on a single act of registering shopper's data in a relation between a single shopper and multiple vendors. Such acts of trade are particularly sale/purchase acts.

In another aspect, the invention concerns a method of performing electronic acts of trade that allow a shopper to search and choose items offered by multiple vendors in a single front end interface. This single ambience is particularly a site on the Internet and its related pages.

In another aspect, the invention concerns a system that allows and supports the achievement of the method of the present invention.

Therefore, the invention concerns a method of performing electronic acts of trade involving a single shopper and two or more integrated stores, comprising the following steps:
a. A shopper accesses a site of the integrated stores, with offers of goods and/or services for sale;
b. The shopper may browse through the items offered in such a site or may search for specific items;
c. When the shopper finds products of his interest, he may add them to a shopping cart;
d. When done adding products to the shopping cart, the shopper may go to checkout to place the purchase orders for the items contained therein;
e. Before directing the purchase orders to the respective integrated stores, the user has the registration of his data verified, which, if non existent, is then requested, or, if already existing in at least one of the integrated stores, is imported to supply the information;
f. Once the registration step is cleared, the shopper chooses purchase conditions, and indicates agreement with them;
g. The purchase orders are then directed to the respective integrated stores.

The integrated stores may either directly deliver the purchase items to the shopper or indirectly, through some other adequate way, for instance through a centralized system set up by the integrated stores.

Without excluding any possible alternatives, the access to the site of the integrated stores is particularly achieved through a web connection or a mobile connection.

“A site of the integrated stores” is typically a front end interface where the shopper interacts with the integrated stores.

The search for items on the site of the integrated stores is performed in any known way, particularly by keywords.

The shopping cart is any kind of electronic treatment through which a chosen item is placed in a reserved ambience for further processing. Typically it is presented to the user as a button on the screen.

The checkout procedure is any kind of electronic treatment that transports the items contained in the shopping cart to the next activities related to the purchase itself of such items. Typically it is presented to the user as a button on the screen.

In an alternative embodiment of the method, items already contained in the shopping cart can be withdrawn before the shopper agrees to purchase them, or, conversely, additional items can be included before the confirmation of the purchase.

The registration of user data may be used to create an account before each concerned integrated store, and is advantageously associated with a unique identifier (for instance the user's e-mail address) by the system.

The site of the integrated stores may contain messages, advertisement, and promotions, for example on the opening screen.

Concerning step b of the method, once search results are obtained, they may be filtered and prioritized according to user preferences, pre-defined to be used for filtering and prioritization purposes, such as favorite stores and brands, price sensitivity, delivery time, and so forth. In one alternative, the prioritized list is displayed to the user, along with product recommendations generated by the integrated stores and the system's own recommendations, derived from historical pattern mining.

Still concerning step b of the method, the user may want to look in more detail at one or more products returned by search results, so the product page is made to display more information about a product, gathered particularly from the integrated store offering it. In one embodiment, when multiple stores offer the same product, the user can choose the most attractive one, and a default suggestion is made based on user's prioritization preferences. A product page may also include recommendations.

As the user adds goods to the shopping cart, in a preferred embodiment the system automatically creates another shopping cart for the specific integrated store offering that product. From that point on, both carts will be synchronized throughout the user's session, ensuring that the products the user wants to purchase are reserved and available.

For the checkout process, it is necessary to place orders with a number of different stores, but advantageously this is invisible to the user. The stores are sorted, and orders are placed, for instance, sequentially. The user's involvement and input may be requested only when strictly necessary, for instance to provide payment information, which may optionally not be stored by the system for security reasons.

In order to place orders, the user may have to register with some of the stores, and may already be a registered customer with others. The system can automatically handle registration, filling in form details with information extracted from accounts in other stores or already in the system itself. The system can also verify if registration information across stores is consistent, and prompt the user to fix inconsistencies if they so desire. All automation may take place with explicit user authorization. The user, as desired, may be given the option of filling in all this information manually through the system's user interface.

Once all needed accounts are registered and necessary details are provided, the orders are placed with the integrated stores. Confirmation messages are optionally displayed and sent through email. The system then may no longer be involved with the processing and fulfillment of these orders, as all billing, handling, and shipping may be performed directly by the integrated stores.

In addition to the aspects described above, there are alternative embodiments of the invention, as follows:
Users may create permanent search queries, for products they buy on a recurring basis, or for special purchases they want to monitor for an extended time period, waiting for a specific deal to become available. A user can have as many permanent searches as desired, and periodic search result updates can be sent through email.
The system may automatically select the best offer among a set of search results from various integrated stores, based on user preferences and history. This automated selection of the best offer may be activated by user settings or on a case by case basis, allowing for quick purchases of single items.
The system can automatically mine patterns from historical search and order data, which provides various ways to suggest products to the user. Suggestions may be based on products that are often searched for in the same user session, or that are often visualized or bought together; or visualized or bought by other users with similar histories; and so forth. This data mining process is typically performed on anonymized data, in order to preserve user privacy. Whether a user has an account or a purchase history with a specific store may also taken into consideration.
As new stores are integrated into the system, user accounts may be automatically created on them, optionally with express approval by the user, the store or both. The user has the option to approve this automated registration on a case by case basis, and users with fairly specific, niche interests can use these registrations to direct search results and recommendations.

### The System

In another aspect, the invention concerns a system for performing the electronic acts of trade according to the method described hereinbefore.

The system comprises at least (A) one or more applications servers, (B) one or more database servers and (C) one or more store integration servers, such a system being accessible by users through any adequate application, the application servers (A) hosting (a) an account manager, (b) an order manager, (c) a search agent, (d) a shopping cart manager, (e) an optional history pattern miner, and (f) an optional recommendation agent; the database servers (B) comprise user account information, preferences and user history related to prior searches, browsing and orders, and the integration servers (C) host (a) a store cache manager and (b) a store interaction automator.

### Features of the Account Manager

The Account Manager is responsible for user account creation, updating, and integration with accounts on integrated stores, including guaranteeing consistency of user information across stores. A user may have accounts in any number of stores integrated by the system. The system can automatically import account information from an integrated store to fill its own account database. The system can also automatically create new accounts using information from its own account database. Both imports and exports may need express authorization from the user. The Account Manager also handles user preferences, which are used by other components for contents prioritization and filtering.

### Features of the Order Manager

The Order Manager is responsible for order submission once the user decides to make a purchase. The order manager groups items in the shopping cart by integrated store, and proceeds sequentially, submitting orders to each integrated store through the Store Interaction Automator. The user is involved only when necessary, which happens when he has to provide payment option details, which may not be stored by the system for security reasons. Once an order is submitted, it is recorded in the database for future mining.

### Features of the Search Agent

The Search Agent is responsible for submitting search queries to the integrated stores through the Store Interaction Automator, combining results obtained from different stores, filtering and prioritizing them according to user preferences, typically displaying them to the user, optionally along with recommendations generated by the Recommendation Agent. Users may register “permanent searches” for specific queries, which allow them to monitor supply and price for products of interest. Search queries and their results are recorded in the database for future mining. Given a high volume of search history data, it is advantageous that the system stores this data as compact data, which may be done through a specific data store.

### Features of the Shopping Cart Manager

The Shopping Cart Manager controls the user's shopping cart. This involves synchronizing the system's cart with corresponding carts on integrated stores whenever the user adds or removes an item, or updates quantities. By ensuring synchronization, the system guarantees that items selected by the users are available for purchase. Synchronization is obtained through the Store Interaction Automator, which creates and manipulates remote shopping carts. Whenever items are added to the shopping cart, recommendations may be displayed.

### Features of the History Pattern Miner

The History Pattern Miner extracts historical data from the database, consisting of search and order history. The information is preferentially anonymized before further processing, in view of user privacy. The historical information is optionally fed to pattern mining applications, which attempt to find product suggestions based on similar searches and orders, and/or on (identified or unidentified) users with similar histories. These suggestions are provided to the Recommendation Agent.

### Features of the Recommendation Agent

The Recommendation Agent combines suggestions derived by data mining, obtained from the History Pattern Miner, with suggestions offered by the integrated stores themselves. The suggestions may be filtered and prioritized according to user preferences. Suggestions may then be displayed along with search results (suggesting other searches that often go together with the one being performed), product information (suggesting products that are often purchased together), shopping cart contents and operations (again, suggesting products that are often purchased together), and also on the home page for registered users.

### Features of the Store Cache Manager

The Store Cache Manager periodically submits searches to the integrated stores concerning their most commonly sought products. Advantageously, the results are stored locally, greatly reducing the bandwidth costs and the latency associated with the system, as product search is a very common user operation. These results are used by the Store Integration Automator, but the existence of the cache is advantageously completely transparent to the other system components.

### Features of the Store Interaction Automator

The Store Interaction Automator automatically communicates with the integrated stores web sites for performing all operations that involve the integrated stores. This component allows the system to search their catalogs; create, retrieve, and update account information for the users; fetch product recommendations; manage a shopping cart on behalf of the users; submit purchase orders on behalf of the users. This component is used by the Account Manager, the Store Cache Manager, the Search Agent, the Recommendation Agent, the Shopping Cart Manager, and the Order Manager. It implements specialized code for each store, but its consistency, maintainability and scalability are guaranteed by the use of a state machine, whose states are the same for all stores.

### Example

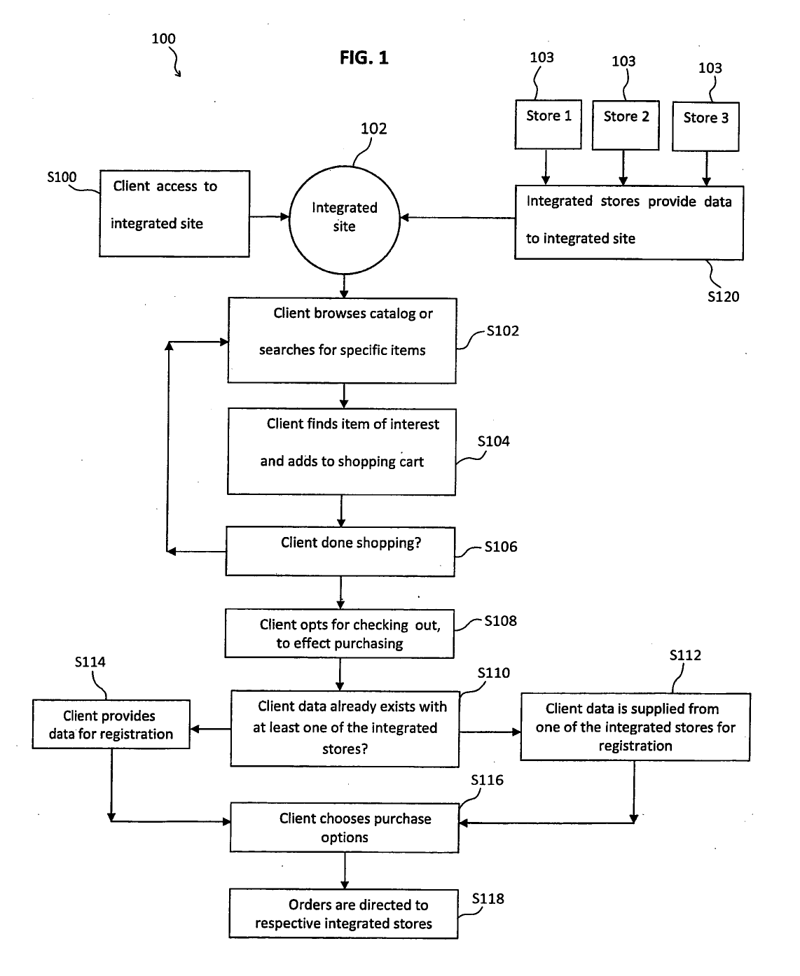

The following example, with the aid of FIG. 1, is given only as a way to demonstrate the many aspects of the invention, with no limitation to its full deployment besides the contents of the attached claims.

It will now be described a typical embodiment of the method of the invention, as a sequence of actions by a typical user and responses from the system.

In step S100, the user logs onto the system 100 including the integrated site 102 through a web or mobile application. The initial screen lets the user browse products offered by integrated stores 103, or search for products based on keywords. Advertisement and promotions are placed on this screen as well.

In step S102, the user submits a search query, which is automatically sent to the relevant integrated stores 103. In order to speed up the search, a cache is used by the system's 100 servers, storing information about often sought products.

Once search results are obtained, they are filtered and prioritized according to user preferences. Users may define a set of criteria to be used for filtering and prioritization purposes, such as favorite stores and brands, price sensitivity, delivery time, and so forth. The prioritized list is displayed to the user, along with product recommendations generated by the integrated stores 103 and the system's 100 own recommendations, derived from historical pattern mining.

The user can look more carefully at one or more products returned by search results. The product page displays more information about a product, gathered from the integrated store 103 offering that product. When multiple stores offer the same product, the user can choose the most attractive one, and a default suggestion is made based on their prioritization preferences. A product page also includes recommendations.

In step S104, the user finds a product of his liking, and adds it to a shopping cart. The system automatically creates a shopping cart on the integrated store 103 offering that product. From now on, both carts will be synchronized throughout the user's session, ensuring that the products the user wants to purchase are reserved and available. Again, once products are in a shopping cart, recommendations from integrated stores 103 and the system's 100 historical pattern mining are displayed.

The user makes more searches, browses through products and recommendation, making a few more purchase decisions and filling up the shopping cart with several products, being sold by different integrated stores 103. Finally, in step S106, the user is finished shopping, and in step S108, decides to proceed to checkout and place an order.

The system 100 will guide the user through the checkout process, which involves placing orders with a number of different stores. The stores are sorted, and orders are placed sequentially. The user's involvement and input are requested only when strictly necessary: to provide payment information, which is not stored by the system 100 for security reasons.

In order to place orders, the user may have to register with some of the stores 103, and may already be a registered customer with others. In steps S110 and S112, the system 100 can automatically handle registration, filling in form details with information extracted from accounts in other stores 103 or in the system 100 itself, if available. The system 100 can also verify that registration information across stores 103 is consistent, and prompt the user to fix inconsistencies if they so desire. All automation only takes place with explicit user authorization, and the user, in step S114, is given the option of filling all this information manually through the system's 100 user interface if desired.

Once all needed accounts are registered and necessary details are provided in step S116, the orders are placed with the integrated stores 103 in step S118, and confirmation messages are displayed and sent through email. The system is no longer involved with the processing and fulfillment of these orders, as all billing, handling, and shipping is performed directly by the integrated stores.

This sample session demonstrates the value of the invention, as the user can not only browse products for sale in multiple stores from a single vantage point but also place orders and manage registration details with multiple stores with no more work than it would be required when all products are offered by a single provider. This is of great benefit both to users and integrated stores, which can reach a wider audience, as complementary stores in effect augment each other's breadth of goods being offered.

1. A computer-implemented method of performing electronic acts of trade involving a single shopper and two or more integrated stores, comprising the following steps:
a. By way of a device able to access an integrated site where integrated stores offer goods and or services for trade, a shopper accesses the site of integrated stores,
b. The shopper may browse through the items offered in such a site or may search for specific items;
c. When the shopper finds products he wishes to buy, he adds them to a shopping cart;
d. When done adding products to the shopping cart, and wishing to perform the purchase, the shopper goes to checkout to place the purchase orders for the items contained therein;
e. Before directing the purchase orders to the respective integrated stores, the user has the registration of his data verified, which registration, if nonexistent, is then requested, or, if already existing in at least one of the integrated stores, is imported to supply the information;
f. Once the registration step is cleared, the shopper chooses purchase conditions;
g. The purchase orders are then directed to the respective integrated stores.

2. The method of claim 1 wherein the access to the site of the integrated stores is done through a web connection or a mobile connection

3. The method of claim 1 wherein, after item d, anytime before placing purchase orders, the shopper may choose to withdraw items already chosen or to go back to browsing or searching for specific items.

4. The method of claim 1 wherein the shopper is prompted to give authorization for his data to be imported from any other of the integrated stores.

5. The method of claim 1 wherein the choice of purchase conditions by the shopper is also imported from any of the integrated stores.

6. The method of claim 1 wherein the shopper is requested to interfere in the registration procedure to fix inconsistencies or to manually input new data.

7. The method of claim 1 wherein the shopper's registration data is associated with a unique identifier, particularly an e-mail address.

8. The method of claim 1 wherein the shopping cart and/or the check out options are presented to the user as buttons on the screen of a connecting device.

9. The method of claim 1 wherein said site of integrated stores also contains messages, advertisement or promotions.

10. The method of claim 1 wherein along step b shopper's search results are filtered and prioritized according to shopper's preferences, pre-defined to be used for filtering and prioritization purposes in shopper's next use of said site of integrated stores.

11. A computer-implemented system for performing the electronic acts of trade according to the method described hereinbefore, comprising at least:
(A) one or more applications server devices,
(B) one or more database server devices
(C) one or more store integration server devices, such a system being accessible by users through any adequate application,
the application server devices (A) hosting (a) an account manager, (b) an order manager, (c) a search agent, (d) a shopping cart manager, (e) an optional history pattern miner, and (f) an optional recommendation agent; the database server devices (B) comprising user account information, preferences and user history related to prior searches, browsing and orders, and the integration server devices (C) hosting (a) a store cache manager and (b) a store interaction automator.
